(19) United States
(12) Patent Application Publication
(10) Pub. No.: US 2024/0196853 A1
(43) Pub. Date: Jun. 20, 2024

(54) MONITORING A MILK MACHINE

(71) Applicant: GEA Farm Technologies GmbH, Bönen (DE)

(72) Inventors: Peter Peters, Hamm (DE); Christoph Zenz, Bochum (DE); Martin Wortmann, Recklinghausen (DE)

(21) Appl. No.: 18/557,497

(22) PCT Filed: Apr. 6, 2022
(86) PCT No.: PCT/EP2022/059101

§ 371 Date: Oct. 26, 2023

(30) Foreign Application Priority Data
Apr. 28, 2021 (DE) 102021110953.1

(51) Int. Cl. A01J 5/013; A01J 7/02

(52) U.S. Cl. CPC A01J 5/0135; A01J 7/02

(57) ABSTRACT

The invention relates to an arrangement (1), comprising: • a milking machine (2) which has a line portion (3) for a fluid; • a monitoring device (4) for monitoring contents of the fluid when the fluid flows through the line portion (3), which monitoring device comprises: o a light-source unit (5) which emits light into the line portion (3), o a detection unit (6) for spectrally resolved detection of light exiting the line portion (3), wherein the detection unit (6) is designed to output a signal on the basis of which the contents of the fluid flowing through the line portion (3) can be determined.

The invention relates to the monitoring of a milking machine on the basis of an analysis of a fluid, in particular milk.

Raw milk is a vital foodstuff and an important raw material for the food industry. In order to protect the consumer, for technical processability and for market management, raw milk must satisfy certain national and international quality requirements.

In milking machines and milking methods in general, and particularly in the case of automatic and automated milking with semiautomatic and fully automatic milking systems, extended functions play an important role. In particular, it is essential to ensure quality standards of milk, and in particular to test for evidently modified milk.

It is known to analyze extracted milk in respect of constituents indirectly or directly after a milking process. In this case, the characteristic absorption spectrum of the constituents is used. If light with a particular wavelength is introduced into the milk, it will be absorbed by the milk if the milk has a constituent that absorbs this wavelength.

From the prior art, it is known to use LEDs having a fixed wavelength for the spectroscopic analysis. This is possible with simple components which, besides the one LED, merely require a light sensor and simple evaluation electronics. Such a component, however, is sensitive only to a particular constituent. When configuring the component, it is therefore already necessary to establish which constituent this is intended to be. According to the prior art, the analysis of a plurality of different constituents requires great outlay, for example by a laboratory study being carried out. Alternatively, a plurality of components having different LEDs would need to be used. In the case of a plurality of LEDs, it is necessary to activate the latter separately one after another and therefore analyze the wavelengths separately from one another. One spectral value is acquired per LED.

On the basis of the described prior art, it is an object of the present invention to provide a way of monitoring a milking machine on the basis of constituents of a fluid flowing through the milking device with little outlay.

This object is achieved by the arrangement and the method according to the independent claims. Further advantageous developments are specified in the dependent claims.

According to the invention, an arrangement is provided. The arrangement comprises:
a milking machine having a line section for a fluid,
a monitoring device for monitoring constituents of the fluid when the fluid is flowing through the line section, comprising
   a light source unit, which emits light into the line section,
   a detection unit for the spectrally resolved recording of light which emerges from the line section, the detection unit being adapted to output a signal, with the aid of which the constituents of the fluid flowing through the line section can be determined.

The described arrangement is used for the analysis of a fluid, preferably milk, in particular bovine milk. The milk may be analyzed indirectly or directly after a milking process. Milk is in this case intended to signify not only pure milk but also adulterated milk. A mixture of pure milk and blood or chemicals such as cleaning agents or dipping agents constitutes adulterated milk and is also referred to herein as “milk”. Alternatively, the fluid may for example be a cleaning agent.

An analysis is intended to signify that the fluid is studied in respect of its composition. Milk as the fluid may in this case be studied in respect of constituents such as fat, protein and lactose or in respect of contaminants such as antibiotics, dipping agents, cleaning agents or water. It is also possible to ascertain whether the milk contains solid particles, flocculation, foam and bubbles. In the case of a cleaning agent, the composition of the latter may be determined.

The analysis may consist in distinguishing between the presence and absence of particular entities, without quantifying these entities. For instance, it is possible to ascertain whether milk is adulterated or a cleaning agent contains a particular substance. Alternatively or in addition, it is possible to establish for example the proportion of fat which the milk has.

The absence of a particular constituent may, in particular, be established by this constituent not being present in a measurable quantity in the fluid. The milk may, for example, be studied in respect of whether the milk contains blood and/or urea. The milk adulterated with blood and/or urea in an elevated form may then be rejected before it is mixed with other milk. In addition, blood in milk may indicate an injury to the animal from which the milk has come. If blood is identified, the corresponding animal may be subjected to an examination in order to check the health condition of the animal. Moreover, the analysis may consist in quantifying constituents. For example, the proportion of protein, fat and/or lactose in milk may be determined, or the proportion of a cleaning agent in a cleaning fluid may be determined.

The arrangement may contribute to the monitoring of the milking machine, in particular to the process monitoring of the latter. For example, variations in the composition of the fluid as a function of time may be identified with the arrangement. This is relevant in particular for the concentration of cleaning agents in milk. With the arrangement, the lactation cycle or a pregnancy of an animal may be identified. In addition, the arrangement may be used for flow identification. In this way, for example, it is possible to distinguish between a milking process and a cleaning process. Preferably, the arrangement is adapted to output a working instruction, for example in the form of an alert or a warning, in response to the ascertained results.

The arrangement comprises a milking machine. The milking machine comprises one or more milking stalls. For each milking stall, the milking machine preferably has a respective milking cluster. The milking clusters are preferably connected via a line system to a milk tank of the milking machine. The milking machine may furthermore have a cleaning device for cleaning the line system and/or the milking clusters. Preferably, the milking machine comprises everything which is used for the milking to the transfer of the milk, for example to a transport vehicle. The milking machine may also be referred to as a milking system or a milking installation.

The milking machine comprises a line section for the fluid to be analyzed. A line section is to be understood as a part of a line through which the fluid can flow. The line section may, for example, be part of a tube or a hose. The line section has at least one inlet, through which the fluid can be introduced into the line section, and at least one outlet, through which the fluid can leave the line section. The at least one inlet and the at least one outlet are different to one another. The line section need not be delimited separately from the rest of the line. In particular, it is not necessary for the line section to extend over precisely one tube component. The at least one inlet and the at least one outlet merely define respectively the start and end of the line section, and for example need not coincide with the joint between adjacent tube components. The line section is physically defined merely in that the arrangement is adapted to analyze the fluid inside the line section. This means that the line section extends at least over a measurement region inside which the fluid can be analyzed. The measurement region need not, however, comprise the entire line section. In particular, it is possible for the measurement region not to extend over a complete line cross section.

The monitoring of the fluid may take place at any desired position of the milking machine. In particular, any position through which marketable milk or even non-marketable milk flows may be envisioned as a monitoring location. For marketable milk, any position from the milking cup of a milking cluster (quarter-individual region) to the milk tank may be envisioned. For non-marketable milk, all lines and component parts through which, for example, a foremilk which is branched off or contaminated milk (for example contaminated by antibiotics) flow may be envisioned. The regions for marketable and non-marketable milk may overlap or be entirely separate from one another. That the described positions are intended for milk does not mean that milk is necessarily the fluid to be monitored at these positions. For instance, a cleaning agent, which flows between two milking processes through a line section through which milk flows during the milking, may also be the fluid to be monitored.

Preferably, the milk of a particular teat may be analyzed. Preferably, in this case a respective monitoring location is provided for each teat so that the milk of an animal can be analyzed individually per teat. In the case of cows, this analysis may be referred to as quarter-individual. Alternatively or in addition, a monitoring location may be arranged downstream of a milk claw so that the milk can be analyzed individually per animal. Alternatively or in addition, a monitoring location may be arranged between the milking stall and the milk tank. Alternatively or in addition, a monitoring location may be arranged in the region of a convergence of the milk from a plurality of milking stalls. Alternatively or in addition, a monitoring location may be arranged directly at the milk tank. It is also conceivable for a monitoring location to be arranged between automated cleaning equipment and a milking stall. A monitoring location may also be arranged in lines for non-marketable milk.

The arrangement furthermore has a monitoring device. The latter is adapted to monitor the constituents of the fluid when the fluid is flowing through the line section. The monitoring device may be firmly connected to the line section. Alternatively, it is possible to bring the monitoring device to the line section temporarily for the monitoring.

It is sufficient for the arrangement to have a single monitoring device. It is, however, also possible for the arrangement to have two or more monitoring devices. These may monitor the fluid simultaneously at different monitoring locations. The accuracy of the monitoring may be increased in this way. At the same time, by comparing the measurement values it is possible to check whether defects or wear are interfering with the measurement.

With the monitoring, it is possible in particular to detect contamination of the fluid, for example in the case of milk by antibiotics, dipping agents, cleaning agents and/or water. Alternatively or in addition, flocculation, foam and/or bubbles in the fluid may be identified by a phase discrimination or by a physical analysis. In addition, the filling level of the line section may be detected. For the process monitoring, it is possible to carry out milk flow identification, a flow analysis, identification of defects (for example at seals) and/or a comparison between an expected state and an actual state. Furthermore, the monitoring device may be used to monitor cleaning and/or to optimize cleaning. The monitoring device may also be used for quality testing, by monitoring dipping agents, cleaning agents and/or water as the fluid. In addition, it is possible to use the monitoring device to monitor wear, for example in the case of silicone hoses or silicone component parts of the milking machine. This is the case because fat or other substances may diffuse into silicone material. This may be identified by the monitoring device.

The monitoring device may in addition be used for the separation of calf milk. For this purpose, the milk may be analyzed in a line section which is part of a branch line, through which calf milk is branched off. The quality of the calf milk may be ensured in this way.

The monitoring device has a light source unit and a detection unit. By means of the light source unit, light can be introduced into the line section, for example through a window in a boundary of the line section. By means of the detection unit, light which emerges from the line section, for example through a further window or the previously described window in the boundary of the line section, may be recorded. The detection unit is preferably tuned to the light source unit. Particularly preferentially, the detection unit covers the entire spectral range emitted by the light source unit. The detection unit and the light source unit are preferably arranged in such a way that the light emerging from the line section, which light originates from the light source unit, can be detected by the detection unit. The detection unit has one or more detectors. The light source unit and the detection unit are used to spectroscopically analyze the fluid. This is possible on account of the detection unit being adapted for spectrally resolved recording of the light. This means that the light intensity can be recorded as a function of the wavelength by the detection unit. A multiplicity of individual spectral values can thus be acquired by the detection unit, in particular from the entire wavelength spectrum of the light emerging from the line section, which light originates from the light source unit. For the spectrally resolved recording of the light, the detection unit preferably comprises a means for spectral decomposition of the light, for example an interferometer or a dispersive element such as a grating or a prism. In the case of a dispersive element, the latter is preferably mounted rotatably. Alternatively, it is possible to use a spatially resolving detector, for example a CCD chip, with which the spectrally decomposed light can be measured at a measurement time point. The measurement accuracy is in this case dependent in particular on the resolution of the CCD chip.

Preferentially, the detection unit has a detector and an interferometer. An interferometer is an apparatus which generates interference by splitting a light beam into two partial beams and by combining the two partial beams with a path difference. The interferometer and the detector are configured and arranged in such a way that light emerging from the line section can be spectrally decomposed by the interferometer and subsequently detected by the detector. By the spectral decomposition of the light by the interferometer, the detection unit can record the light in a spectrally resolved fashion. The interferometer thus makes it possible to ascertain a multiplicity of individual spectral values, in the light emerging from the line section, within the preferably continuous wavelength spectrum of the light source unit. The interferometer may, for example, be a Michelson interferometer or a Fabry-Pérot interferometer. These two interferometers have a moving mirror. Preferably, the interferometer has a flexible element, in particular precisely one flexible element, which generates different partial spectra of the overall spectrum of the light source unit.

The detection unit may be adjusted and/or calibrated in an automated fashion by feedback of reference values. The detection unit may be adapted specifically to the customer and/or herd. Moreover, variations of the light source unit as a function of time may be compensated for.

The arrangement is adapted to analyze the fluid inside the line section by the light source unit and the detection unit being aligned with the line section. The measurement region formed with the light source unit and the detection unit for the analysis of the milk is therefore located in the line section. The line section is to this extent distinguished from other parts of the line. It is sufficient for the arrangement only to exist during the analysis per se. Before and after the analysis, the monitoring unit may be removed from the line section.

The arrangement preferably comprises a micro-electromechanical system, abbreviated to MEMS. A MEMS is a component having a mobile microscopic structure. The latter can be actuated by mechanical stress or by applying an electrical voltage. The detection unit may thus be produced by an interferometer with a moving mirror being embodied as such a microscopic structure. The light source unit may be arranged in a fixed alignment with respect to the MEMS, for example in the form of a combined component or in a common housing. The light source unit and the detection unit are preferably arranged in a fixed position and alignment relative to one another. Such an apparatus is particularly small, robust and easy to integrate, and allows relatively simple analyses outside a laboratory. In addition, such an apparatus can be produced relatively simply and economically in large numbers.

That the monitoring device has a light source unit means that one or more light source units are provided. The light source unit preferably comprises one or more light sources. If a light source unit has a plurality of light sources, the latter are preferably configured identically to one another. Alternatively, a continuous spectrum which covers a desired spectral range may be obtained by LEDs coordinated with one another as light sources. A plurality of light sources may be arranged so that the entire measurement range is illuminated uniformly. The light sources may be identical or different. A particularly broad wavelength spectrum may be obtained by combining different light sources. It is also conceivable for the light source unit to have a plurality of discontinuous light sources, for example vapor lamps, in particular sodium vapor lamps or mercury vapor lamps. It is also possible for the light source unit to be formed by an external radiation source being coupled in, for example via an optical waveguide. The light source unit is in this case formed only by the optical waveguide.

With the described arrangement, the fluid may be analyzed in the line section. The fluid may thus be analyzed while the fluid is flowing through the line section. It is not necessary to take and analyze random samples. Taking random samples would on the one hand be more elaborate than analysis in a line section that is being flowed through. On the other hand, the results of a random sample analysis are typically subject to a delay. If milk were already to have been mixed with other milk after taking the random sample, all of the milk might therefore need to be disposed of. By analysis in the line section, conversely, adulterated milk may for example be rejected particularly rapidly and simply, in particular before this milk is mixed with other milk. Furthermore, the described apparatus allows a complete analysis of the fluid and not just the analysis of a random sample. For example, the monitoring device may be used to analyze milk directly after the milking, before the milk is mixed with other milk in a milk tank.

Preferably, the light source unit emits light having a continuous wavelength spectrum into the line section. A continuous wavelength spectrum is intended to signify that there is a wavelength range, each wavelength of which is contained in the light emitted by the light source unit. The wavelength spectrum thus in any event has a section without gaps. This does not preclude the wavelength spectrum having a plurality of continuous sections, between each of which there is a respective gap. It is, however, preferential for the wavelength spectrum to be free of gaps as a whole. The wavelength spectrum is preferably a broadband continuous wavelength spectrum. The term “broadband” is intended to be interpreted in relation to the detection range of the detection unit. The wavelength spectrum preferably has wavelengths which lie at least 200 nm, in particular at least 500 nm apart from one another. In that case, the wavelength spectrum covers a wavelength range which is at least 200 nm or 500 nm wide, respectively, each wavelength of which is contained in the light. Particularly preferentially, the wavelength spectrum covers at least the wavelengths in the range of from 1350 to 2500 nm. The wavelength spectrum preferably lies in the near infrared range and/or in the medium infrared range. In that case, the analysis of the fluid involves infrared spectroscopy. It is, however, also conceivable for the wavelength spectrum to cover the visible light range fully or completely and/or the UV range fully or completely. Particularly preferably, the wavelength spectrum covers a wavelength range with which chemical bonds in the fluid to be analyzed can be excited. The so-called spectral fingerprint of the fluid may thus be ascertained. The wavelength spectrum of the light emitted by the light source unit is preferably in any event constant in a section. For example, the wavelength spectrum may be a Planck spectrum, as in black-body radiation.

By the light source unit with a continuous spectrum, the fluid may be analyzed in respect of various constituents. This may, in particular, be carried out in the manner of dispersive spectroscopy. The monitoring device is therefore not restricted to the analysis of a single constituent. When configuring the monitoring device, designation of a particular constituent is therefore not necessary. Designation of a particular fluid to be monitored is not even necessary. In this regard, the monitoring device may be used particularly flexibly.

The detection unit outputs a signal, with the aid of which the constituents of the fluid flowing through the line section may be determined. This signal preferably contains only information about the spectrally resolved light recorded by the detection unit.

The monitoring device may have an evaluation unit. The evaluation unit is preferably adapted to analyze the fluid in respect of constituents with the aid of signals of the detection unit. The evaluation unit may be arranged in a housing together with the light source unit and the detection unit. In that case, the entire analysis may be carried out in the monitoring device.

Alternatively or in addition to the use of an evaluation unit as part of the arrangement, the analysis of the fluid may also take place outside the arrangement, for example by a central server and/or by a cloud application. The arrangement preferably has an interface, via which the signals of the detection unit can be output, in particular to an external evaluation unit which is adapted to identify constituents of the fluid with the aid of signals of the detection unit. The arrangement and the external evaluation unit may be connected to one another by means of a cable, by means of a wireless connection and/or by means of an Internet connection.

The evaluation preferably takes place in the manner of Fourier transform spectroscopy, particularly in the manner of infrared Fourier transform spectroscopy (abbreviated to FTIR). From the spectrum thereby obtained, it is possible to identify which constituents are present in the fluid. For example, it is possible to determine whether the spectrum has a peak at a characteristic wavelength of a particular constituent. Constituents may also be quantified. For this purpose, the height of a peak may be ascertained.

In order to analyze the fluid, the signals emitted by the detection unit may be evaluated in the manner of dispersive spectroscopy. For this purpose, a complex evaluation algorithm is preferably used, with which the presence and optionally also the concentration of constituents of the fluid can be calculated. The evaluation algorithm uses the measured spectral information as input parameters and calculates therefrom the desired characteristics or values to be ascertained.

The evaluation algorithm may be obtained from a separate system with the aid of reference data and/or by using a machine learning program. The signals output by the detection unit contain information relating to the light recorded by the detection unit. Particularly in the case of a light source unit having a continuous spectrum, the monitoring device may be reconfigured particularly simply in order to analyze other constituents. In particular, no modification to the hardware is necessary for this. Instead, it is sufficient to change the evaluation algorithm. It is also possible to adjust the measurement accuracy by adapting the software of the evaluation unit, for example in coordination with a measurement duration. The analysis may thus be varied by altering the software, for example by a software update. By a software update, in particular the functional scope of the evaluation may be extended, for example by enabling a previously blocked function or a function extension (actual addition of the function). The functionality of the evaluation may thus be modified without a design change.

The analysis of the fluid may take place with the aid of the light reflected and/or absorbed by the fluid. In order to use the reflected light, the light source unit and at least one detector of the detection unit are arranged on the same side of the line section. The light from the light source unit may thus be introduced into the line section, reflected by the fluid in the line section and travel from the line section into the at least one detector of the detection unit. The light source unit and the detection unit may be arranged next to one another, for example inside a common housing. This configuration is preferred because of the possibility of this compact structure. In particular, in this configuration it is preferential for the monitoring device to comprise a MEMS.

In order to use the absorbed light, the light source unit and at least one detector of the detection unit are arranged on mutually opposite sides of the line section. The line section is in this case arranged between the light source unit and the at least one detector of the detection unit. The light from the light source unit may thus be introduced into the line section and, if it is not absorbed by the fluid in the line section, travel from the line section into the detector.

If the detection unit has a plurality of detectors, the latter are preferably all arranged on the same side of the line section. Thus, either the reflected light may be recorded by all the detectors or the absence of the absorbed light may be recorded by all the detectors. It is also conceivable for the detection unit to have respectively one or more detectors on the side of the light source unit and on the opposite side. In that case, both the reflected light and absorbed light may be taken into account.

In one preferred embodiment, the milking machine furthermore has a main line, with the line section branching off from the main line and debouching into the main line.

The line section runs parallel to the main line. In this embodiment, therefore, not all of the fluid is analyzed. Nevertheless, the monitoring device allows more comprehensive analysis of the fluid than the study of individual random samples. Lastly, a part of the fluid flow may be studied continuously with the described arrangement.

The term “main line” refers, in distinction to the term “branch line”, merely to the fact that the analysis of the fluid takes place in the branched-off line section, and therefore in a separate part of the line. It is not necessary for the main line to have a larger flow cross section than the branched-off line section.

Upstream of the measurement region, the line section preferably has a filter screen. The latter may for example be arranged at a branching location at which the branch line branches off from the main line. Solid particles having a corresponding minimum size may be kept away from the line section by the filter screen. In this way, obstruction of the line section may be prevented.

In another preferred embodiment of the arrangement, the line section can be shut off, in particular by a shut-off element inside the line section.

In this embodiment, the fluid may be fully stopped in order to carry out the analysis. The analysis takes place discontinuously. In this way, a particularly high measurement accuracy may be achieved.

In another preferred embodiment of the arrangement, the light source unit comprises an incandescent emission source.

Incandescent emission sources emit a continuous wavelength spectrum. In addition, they are relatively inexpensive. The incandescent emission source is preferably a halogen lamp. Such a lamp has a high and directional intensity.

In another preferred embodiment of the arrangement, the line section has an at least partially transparent region, the monitoring device being configured as a handheld instrument, in such a way that when the handheld instrument is held on the at least partially transparent region of the line section, light emitted by the light source unit enters the line section and light emerging from the line section reaches the detection unit.

In principle, any transparent milk-carrying region of the milking machine is suitable to be employed for a spectroscopic analysis. This is used in the present embodiment insofar as the monitoring is carried out with a handheld instrument that can be held on such a transparent region of the line section. This is particularly flexible insofar as the handheld instrument may be used without great outlay at different locations of the milking machine, for example in order to study the respective composition of milk there. The milking machine preferably comprises all regions through which milk or cleaning agent flows from a milking cup of a milking cluster to a milk tank, and from a cleaning controller to a discharge. The monitoring device may be used at any location of the milking machine defined as comprising these regions.

The at least partially transparent region is formed in the boundary of the line section. Through the at least partially transparent region, light can enter the line section and emerge from the line section. That this region is at least partially transparent means that this region is transparent for at least one spectral range. It is sufficient for the region to be transparent for the wavelengths that are relevant for the analysis.

The at least partially transparent region may be configured as a viewing window in the boundary of the line section. Various viewing windows may be provided at different locations in the milking machine. Each viewing window may then be envisioned as a monitoring location. In order to use a viewing window for the monitoring, the handheld instrument may be held at this viewing window. A spectrum may be acquired and analyzed there. A plurality of monitoring devices may be used simultaneously at different monitoring locations.

Alternatively, it is also possible to use a line section consisting for example of silicone, which as such is already at least partially transparent. In that case, the at least partially transparent region may extend over the entire line section. When suitable wavelength ranges are used (for example in the infrared range), silicone hoses are transparent. The monitoring may then be carried out at any point of any silicone hose of the milking machine.

It is also conceivable that the monitoring device or a part thereof can be fitted onto a line section configured as a hose, particularly in the manner of a hose clamp. This is expedient particularly in the case of a silicone hose. The monitoring device or part thereof may therefore be fixed on any point of a silicone hose of the milking machine, depending on the desired use.

As a further aspect of the invention, a method for the analysis of a fluid in a line section of a milking machine is provided. The method comprises:
a) introduction of light into the line section,
b) spectrally resolved detection of light which emerges from the line section,
c) analysis of the fluid in respect of constituents with the aid of the light detected according to step b).

The described advantages and features of the arrangement are applicable and transferable to the method, and vice versa. The method is preferably carried out with the described arrangement. The arrangement is preferably suitable for carrying out the described method. The described method may also be referred to as an inline analysis.

It is sufficient to carry out steps a) to c) once respectively. In this way, an instantaneous snapshot may be obtained. It is, however, preferred for steps a) to c) to be carried out several times respectively. A series of spectra may thus be acquired and respectively evaluated. Thus, in particular, the fluid may be analyzed at constant time intervals. In this way, a development as a function of time during a milking process or during a cleaning process may be recorded.

In one preferred embodiment of the method, before step c) an evaluation algorithm is created by machine learning, the fluid being analyzed in step c) by using the evaluation algorithm.

In order to create the evaluation algorithm, signals of the detection unit are fed together with corresponding reference values to the machine learning program. The reference values may be obtained by a fluid analyzed as described additionally being analyzed by a laboratory study, for example. In this case, patterns between features of the signals of the detection unit and the reference values are identified.

The machine learning program may be part of a separate device. In particular, the machine learning program may be installed on a computer which is not part of the arrangement described here. The machine learning program may, for example, be installed on a development tool.

The evaluation algorithm may be created with the separate device and subsequently—if the monitoring device has an evaluation unit—transmitted to the evaluation unit. Alternatively, the evaluation algorithm created with the separate device may be transmitted from the separate device to a server used for analyzing the milk. Permanent contact between the separate device and the evaluation unit, or the server, is not necessary for this purpose. The signals of the detection unit may be transmitted to the separate device in a variety of ways, for example via the Internet or via a cable connection. If the monitoring device has an evaluation unit, the created evaluation algorithm may be transmitted in the same way to the evaluation unit. The separate device may be spatially distanced from the evaluation unit or arranged together with the latter in a common housing.

The evaluation algorithm may be created or modified through machine learning by the evaluation unit or a server actually used for the analysis of the fluid, for example by using artificial intelligence.

It is sufficient for the evaluation algorithm to be created once. For example, in a learning phase a multiplicity of signals of the detector unit may be processed with a respectively corresponding reference value. It is preferential for the evaluation algorithm to be revised, in particular at regular time intervals. For this purpose, in a new learning phase a new evaluation algorithm may be created or the previous evaluation algorithm may be updated. The described arrangement preferably comprises a device for creating an evaluation algorithm from signals of the detection unit and corresponding reference values. The device preferably has a machine learning program. The evaluation unit is in this case adapted to analyze the milk with the aid of signals of the detection unit by using the evaluation algorithm. A server which is likewise used for analyzing the fluid may also be envisioned as the device.

The method preferably furthermore comprises:
d) outputting a signal if a constituent identified in step c) exceeds a corresponding limit value.

By step d), for example, a farmer may be provided with a working instruction of how to respond to the presence of a particular constituent. For example, the arrangement may have a display device via which the working instruction is displayed in response to the signal output in step d). The signal output in step d) may alternatively or in addition be implemented in an automated fashion. If blood is identified in the milk, for example, the milk adulterated in this way may be rejected automatically by a corresponding valve being operated in response to the signal output in step d). In addition, the working instruction to examine the cow in question for injury may be displayed to the farmer.

In another preferred embodiment of the method, steps a) to c) are carried out at least at two monitoring locations, the results obtained in step c) for the at least two monitoring locations being compared with one another.

The two monitoring locations may be arranged in the same line section or in different line sections. For example, the two monitoring locations may be formed by a respective viewing window. It is not, however, necessary for the monitoring locations to be identified by structural features per se. The monitoring locations are already defined per se by corresponding monitoring being carried out at the monitoring locations.

If the results from two monitoring locations are compared with one another, it is possible to identify what is happening between these two monitoring locations. For example, a first monitoring location may be arranged before a possibly critical point of the milking machine and a second monitoring location may be arranged after the possibly critical point. By comparing the measurements before and after the possibly critical point, the influence of this point on the fluid may be studied. If an adulteration takes place at the possibly critical point, for example, this may be identified. This may be used to find out harmful influences, possibly due to defects. It is therefore preferential for a pump, a seal, a valve and/or a line bend to be arranged between the two monitoring locations. These locations respectively represent a possibly critical point at which deposits may occur, for example in dead water regions.

In another preferred embodiment of the method, whether at least one predetermined constituent in the fluid exceeds a respective limit value is determined in step c).

In this embodiment, the presence or absence of one or more particular constituents is studied. This is expedient, for example, for blood and urea as constituents of milk. In this case, a distinction is made between presence and absence with the aid of the predetermined limit value.

In another preferred embodiment of the method, an evaluation algorithm used in step c) is modified.

In this embodiment, the described analysis of the fluid takes place initially with a first evaluation algorithm and subsequently with a second evaluation algorithm. The evaluation algorithm may, for example, be modified from the first evaluation algorithm to the second evaluation algorithm by a software update. The first evaluation algorithm and the second evaluation algorithm differ from one another, for example, in respect of the detectable constituents of the fluid, in respect of the achievable measurement accuracy and/or in respect of the fluid to be analyzed.

In another preferred embodiment of the method, steps a) and b) are carried out with a handheld instrument which in step c) transmits the information recorded according to step b) to a central computer, in step c) the central computer furthermore carrying out the analysis and transmitting the result to the handheld instrument.

In this embodiment, the handheld instrument may be configured relatively simply and economically. The analysis takes place with the central computer, so that the handheld instrument does not need to have the computing power required therefor. Transmission between the handheld instrument and the central computer may in some cases take place via radio. Particularly preferentially, the transmission between the handheld instrument and the central computer takes place via the Internet, in particular by a mobile data connection.

The data ascertained by the monitoring device may, for example, be transmitted to a herd management system on the central computer. The central computer may be configured as a cloud application. Instead of a single central computer, a multiplicity of computers or computer elements interacting with one another may be used.

The results ascertained by the central computer may be transmitted directly to the handheld instrument. Preferably, the results are displayed by the handheld instrument. Alternatively or in addition, the results may for example be displayed and/or further processed by the herd management system or by any other mobile or stationary terminal.

In another preferred embodiment of the method, steps a) to c) are carried out cyclically, a respective calibration being carried out between successive cycles.

The spectrum emitted by the light source unit may vary over time. The spectrum may also vary every time the light source unit is turned on. It is therefore preferential for the spectrum emitted by the light source unit to be measured at regular intervals as a reference. Particularly preferentially, a respective reference spectrum is acquired directly before each measurement for the analysis. If the analysis is carried out with the aid of the reflected light, the spectrum measured for the analysis may be compared with a reference spectrum that has been measured with an ideal reflector. If the analysis is carried out with the aid of the absorbed light, the spectrum measured for the analysis may be compared with a reference spectrum that has been measured with an empty line section.

In the ideal case, each individual measurement may be compared with a reference measurement. In this way, even temporary fluctuations in the intensity of the light source could be compensated for. In the embodiment described, a respective calibration therefore takes place between the cycles. This respectively takes place between step c) of a first cycle and step a) of the following cycle.

As a further aspect, a method for the analysis of a fluid in a milking machine is provided. The method comprises:
A) branching of a part of the fluid off from a line section of the milking machine,
B) introduction of light into the fluid branched off according to step a),
C) spectrally resolved detection of light which emerges from the fluid,
D) analysis of the fluid in respect of constituents with the aid of the light detected according to step C).

The described advantages and features of the arrangement and of the method described above are applicable and transferable to the method described here, and vice versa.

In the method described here, the fluid is analyzed not inline but after sampling. The measurement therefore does not take place while the fluid is flowing through a line section. Thus, for example, in step A) the fluid may be taken from a line section at a sampling location and put into a container. Steps B) to D) are similar to the inline analysis described above. In this case, however, it is not necessary for the monitoring device to be configured for the line section as described in relation to the arrangement. Instead, it is preferential for the line section to have a sampling location at which the fluid can be taken and put into a container. During the monitoring, the monitoring device is preferably arranged in such a way that the light source unit emits light into the container and the detection unit is adapted for the spectrally resolved recording of light which emerges from the container.

The milking machine preferably has a respective branch line at different locations. From these branch lines, for example, milk may be collected and analyzed. Subsequently, the milk—depending on the result of the analysis—may be returned to the milking machine or disposed of. The milk may also be bottled and stored for subsequent analyses.

Preferably, the milking machine has a respective sampling device, through which a sample of the fluid can be taken from a respective line section, at a plurality of locations. At the sampling devices, for example, withdrawn milk may be collected and, for example, analyzed by a monitoring device configured as a handheld instrument. Subsequently, the milk—depending on the result of the analysis—may be returned to the milking machine or disposed of. The milk may also be bottled and stored for subsequent analyses.

During conventional milking, a sample from the foremilk may be collected manually in a vessel and analyzed.

The invention will be explained in more detail below with the aid of the figures. The figures show particularly preferred exemplary embodiments, although the invention is not limited to these. The figures and the size proportions represented therein are only schematic.

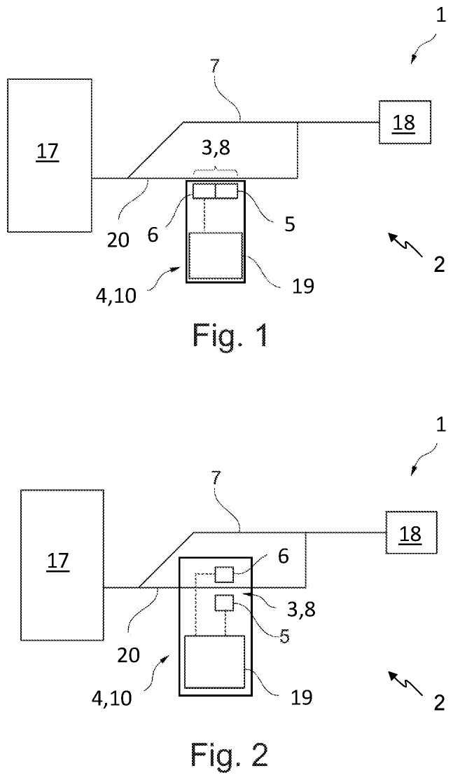

FIG. 1: shows a first embodiment of an arrangement according to the invention,

FIG. 2: shows a second embodiment of an arrangement according to the invention,

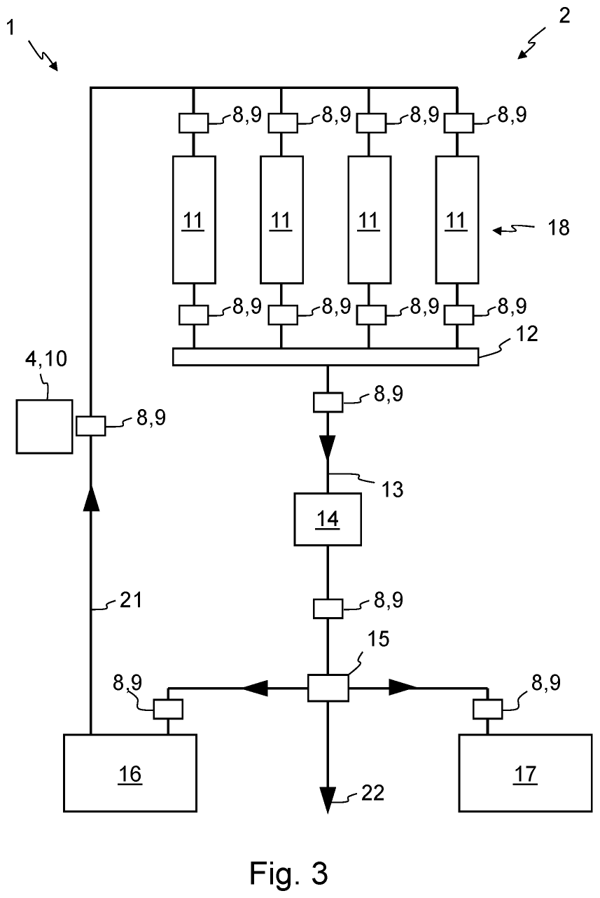

FIG. 3: shows a third embodiment of an arrangement according to the invention.

FIG. 1 shows an arrangement 1 having a milking machine 2. The milking machine 2 comprises a milking cluster 18 and a milk tank 17. The milking cluster 18 is connected by a main line 7 to the milk tank 17. Provided in parallel with the main line 7, there is a branch line 20 which branches off from the main line 7 and debouches back into the main line 7. The main line 7 and the branch line 20 are likewise part of the milking machine 2. A fluid such as milk can be analyzed in a line section 3 of the branch line 20. The milking cluster 18 is connected to the milk tank 17 via the branch line 20, and to this extent via the line section 3. In order to analyze the fluid, the arrangement 1 has a monitoring device 4. The monitoring device 4 has a halogen lamp as a light source unit 5, which emits light having a continuous wavelength spectrum into the line section 3. The monitoring device 4 furthermore has a detection unit 6 for the spectrally resolved recording of light which emerges from the line section 3. The detection unit 6 is connected to an evaluation unit 19 of the monitoring device 4. The evaluation unit 19 is adapted to analyze the fluid in respect of constituents with the aid of signals of the detection unit 6. The fluid may, for example, be analyzed when it is fed through the line section 3 starting from the milking cluster 18. During the analysis, it is possible to determine whether at least one predetermined constituent in the fluid exceeds a respective limit value. The monitoring device 4 is configured as a handheld instrument 10, which can be held on the line section 3. For this purpose, the line section 3 has an at least partially transparent region 8.

FIG. 2 shows an arrangement 1 which is similar to the arrangement from FIG. 1. The only difference here is that the light source unit 5 and the detection unit 6 are arranged on mutually opposite sides of the line section 3. According to FIG. 2, the absorption of light can therefore be measured, while according to FIG. 1 the reflection can be measured.

FIG. 3 shows an arrangement 1 having a milking machine 2. The milking machine 2 has a milking cluster 18 with, for example, four milking cups 11. Extracted milk can be introduced from the milking cups 11 through a milk claw 12 into a milking line 13. Through the milking line 13, the milk can be introduced via a milk airlock 14 and a distributor 15 into a milk tank 17. A vacuum used for the milking is located upstream of the milk airlock 14. Downstream of the milk airlock 14, there is no vacuum. The distributor 15 is adjusted, during the milking, in such a way that the milking line 13 is connected to the milk tank 17. The milk tank 17 may be connected to more than the one milking cluster 18 shown.

The lines of the milking machine 2 may be cleaned with a cleaning fluid. For this purpose, when a milking process is not taking place, a cleaning fluid is introduced from a cleaning fluid tank 16 via a feed line 21 into the milking cups 11. The cleaning fluid can pass through the milking cups 11, the milk claw 12, the milking line 13 and the milk airlock 14 to the distributor 15, while imparting a cleaning effect. From the distributor 15, the cleaning fluid may be disposed of via a discharge 22 or returned to the cleaning fluid tank 16.

The milking machine 2 comprises the milking cluster 18, the milk claw 12, the milking line 13, the milk airlock 14, the distributor 15, the cleaning fluid tank 16, the milk tank 17 and the lines between them, including the feed line 21 and the discharge 22.

A monitoring device 4 configured as a handheld instrument 10 can be held at a respective at least partially transparent region 8 of a corresponding line section 3 at various monitoring locations 9. The milk or the cleaning fluid can thus be monitored in respect of constituents. The indicated positions of the monitoring locations 9 are exemplary. It is sufficient for the arrangement 1 to have any desired one of the monitoring locations 9 indicated. The arrangement 1 may also have any desired combination of a plurality of the monitoring locations 9 indicated or all the monitoring locations 9 indicated. In addition, the arrangement 1 may have one or more further monitoring locations.

### LIST OF REFERENCE SIGNS

1 arrangement
2 milking machine
3 line section
4 monitoring device
5 light source unit
6 detection unit
7 main line
8 at least partially transparent region
9 monitoring locations
10 handheld instrument
11 milking cup
12 milk claw
13 milking line
14 milk airlock
15 distributor
16 cleaning fluid tank
17 milk tank
18 milking cluster
19 evaluation unit
20 branch line
21 feed line
22 discharge

1. An arrangement, comprising:
a milking machine having a line section for a fluid,
a monitoring device for monitoring constituents of the fluid when the fluid is flowing through the line section, comprising
a light source unit, which emits light into the line section, and
a detection unit for the spectrally resolved recording of light which emerges from the line section, the detection unit being adapted to output a signal, with the aid of which the constituents of the fluid flowing through the line section can be determined.

2. The arrangement as claimed in claim 1, wherein the milking machine furthermore has a main line, and wherein the line section branches off from the main line and debouches into the main line.

3. The arrangement as claimed in claim 1, wherein the line section has an at least partially transparent region, and wherein the monitoring device is configured as a handheld instrument, in such a way that when the handheld instrument is held on the at least partially transparent region of the line section, light emitted by the light source unit enters the line section and light emerging from the line section reaches the detection unit.

4. A method for the analysis of a fluid in a line section of a milking machine, comprising:
a) introduction of light into the line section,
b) spectrally resolved detection of light which emerges from the line section,
c) analysis of the fluid in respect of constituents with the aid of the light detected according to step b).

5. The method as claimed in claim 4, wherein the method is carried out with an arrangement as claimed in claim 1.

6. The method as claimed in claim 4, wherein steps a) to c) are carried out at least at two monitoring locations, and wherein the results obtained in step c) for the at least two monitoring locations are compared with one another.

7. The method as claimed claim 4, wherein steps a) and b) are carried out with a handheld instrument which in step c) transmits the information recorded according to step b) to a central computer, and wherein in step c) the central computer furthermore carries out the analysis and transmits the result to the handheld instrument.

8. The method as claimed in claim 4, wherein steps a) to c) are carried out cyclically, and wherein a respective calibration is carried out between successive cycles.

9. A method for the analysis of a fluid in a milking machine, comprising:
A) branching of a part of the fluid off from a line section of the milking machine,
B) introduction of light into the fluid branched off according to step a),
C) spectrally resolved detection of light which emerges from the fluid, and
D) analysis of the fluid in respect of constituents with the aid of the light detected according to step C).
